(19) United States
(12) Patent Application Publication
(10) Pub. No.: US 2018/0169756 A1
(43) Pub. Date: Jun. 21, 2018

(54) SELF-BREAKING SUPPORT FOR ADDITIVE MANUFACTURING

(71) Applicant: General Electric Company, Schenectady, NY (US)

(72) Inventor: Dariusz Oliwiusz Palys, Gebenstorf (CH)

(21) Appl. No.: 15/384,735

(22) Filed: Dec. 20, 2016

(51) Int. Cl. B22F 3/105; B33Y 10/00; B33Y 30/00; B33Y 50/02; B23K 26/342; B23K 26/70

(52) U.S. Cl. CPC B22F 3/1055; B33Y 10/00; B33Y 30/00; B22F 2003/1046; B23K 26/342; B23K 26/70; B33Y 50/02

(57) ABSTRACT

A self-breaking support for a vertically opposed first and second surfaces during additive manufacturing of an object is disclosed. The self-breaking support includes a first base coupled to the first surface and extending towards the second surface; a second base coupled to the second surface and extending towards the first surface; and a self-breaking link coupling the first base to the second base, the self-breaking link including a body and a weakened zone in the body. The self-breaking support breaks during cooling of the object without outside intervention, and can be left in the object.

### BACKGROUND OF THE INVENTION

The present disclosure generally relates to methods for additive manufacturing that utilize supports in the process of building an object, as well as novel supports to be used within these AM processes.

Additive manufacturing (AM) processes generally involve the buildup of one or more materials to make a net or near net shape (NNS) object, in contrast to subtractive manufacturing methods. Though “additive manufacturing” is an industry standard term, AM encompasses various manufacturing and prototyping techniques known under a variety of names, including freeform fabrication, 3D printing, rapid prototyping/tooling, etc. AM techniques are capable of fabricating complex objects from a wide variety of materials. Generally, a freestanding object can be fabricated from a computer aided design (CAD) model. A particular type of AM process uses an energy beam, for example, an electron beam or electromagnetic radiation such as a laser beam, to sinter or melt a metal powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional objects, prototypes and tools.

Selective laser sintering, direct laser sintering, selective laser melting, and direct laser melting are common industry terms used to refer to produce three-dimensional (3D) objects by using a laser beam to sinter or melt a fine metal powder. These processes may be referred to herein as metal powder additive manufacturing. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the metal powder material.

Metal powder additive manufacturing processes create layers of molten metal or an agglomeration of metal over already formed layers of hardened metal. Where the hardened metal is under the new layer, the hardened metal supports the new layer. One challenge of additive manufacturing is building surfaces that are not vertical such as unsupported horizontal surfaces or vertically angled surfaces, i.e., those angled relative to horizontal with no support therebelow. More specifically, where a portion of the new layer is not over a previously formed, now hardened metal, the non-heated metal powder thereabout provides insufficient support and gravity negatively impacts the object's final shape. In order to address this situation, during metal powder additive manufacture of a metallic object, it is known to also form supports as part of the metallic object to support the otherwise unsupported surfaces. For example, supports may be formed in fuel nozzles, such as those used in gas turbines, to maintain separation between parts, e.g., spaced, concentric tubular components in close proximity to one another. In many applications, the supports are removed from the final metallic object, e.g., where operation using the object does not allow for the presence of the supports or support breakage may cause other damage. In these situations, the supports are removed through post-AM processes such as machining or chemical processes. In some cases, supports built into the metallic object are allowed to remain in the object. In this case, stresses, such as thermal stress observed during operation of the metallic object, may be allowed to break the supports. The breakage may be allowed, for example, to improve operation by allowing for more freedom of movement during stresses observed within the object. It is difficult, in some applications, to ensure that the supports are configured to break during operation in a manner that does not otherwise impact the object. While these challenges have been described relative to metal powder additive manufacturing, they are also present in other forms of additive manufacturing.

### BRIEF DESCRIPTION OF THE INVENTION

A first aspect of the disclosure provides a self-breaking support for a vertically opposed first and second surfaces of an object, the self-breaking support comprising: a first base coupled to the first surface and extending towards the second surface; a second base coupled to the second surface and extending towards the first surface; and a self-breaking link coupling the first base to the second base, the self-breaking link including a body and a weakened zone in the body.

A second aspect of the disclosure provides a method for manufacturing a metallic object, the method comprising: forming the metallic object with a self-breaking support using a metal powder additive manufacturing process, the self-breaking support including: a first base coupled to a first surface of the metallic object and extending towards a second surface of the metallic object that is vertically opposed to the first surface, a second base coupled to the second surface and extending towards the first surface, and a self-breaking link coupling the first base to the second base, the self-breaking link including a body and a weakened zone in the body; and allowing the self-breaking link to break during cooling of at least a portion of the metallic object during the forming.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a block diagram of an additive manufacturing process including a non-transitory computer readable storage medium storing code representative of an object according to embodiments of the disclosure.

FIG. 2 shows a cross-sectional view of an illustrative object including a self-breaking support according to embodiments of the disclosure.

FIG. 3 shows an enlarged cross-sectional perspective view of part of the object of FIG. 2 including a self-breaking support according to embodiments of the disclosure.

FIG. 4 shows an enlarged perspective view of a self-breaking support according to embodiments of the disclosure.

FIG. 5 shows a side view of a self-breaking support according to embodiments of the disclosure.

FIG. 6 shows an enlarged front view of a weakened zone of a self-breaking support according to embodiments of the disclosure.

FIG. 7 shows a side view of part of a self-breaking support according to embodiments of the disclosure.

FIGS. 8 and 9 show side views of a self-breaking support and illustrating different stresses according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing an object manufactured as described herein. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular object may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. A “metallic object” as used herein may include any material thing including a metal or metal alloy formed by a metal powder additive manufacturing process, and an “object” can include any material thing formed by additive manufacturing processes, perhaps using materials other than metal such as but not limited to polymers and ceramic composites. Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s). “Substantially vertical” may be +/−5° from vertical, and “substantially perpendicular” as applied to two structures may be 85° to 95°. “Substantially triangular” may refer to a shape having three major sides but with some variation in the shape of the sides, or the number of additional minor sides provided. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or objects, but do not preclude the presence or addition of one or more other features, integers, steps, operations, elements, objects, and/or groups thereof. “Optional” or “optionally” means that the subsequently described event or circumstance may or may not occur, and that the description includes instances where the event occurs and instances where it does not.

As indicated above, the disclosure provides a self-breaking support for a vertically opposed first and second surfaces during additive manufacturing of an object, and in particular, a metallic object formed using metal powder additive manufacturing. A method for manufacturing a metallic object is also described.

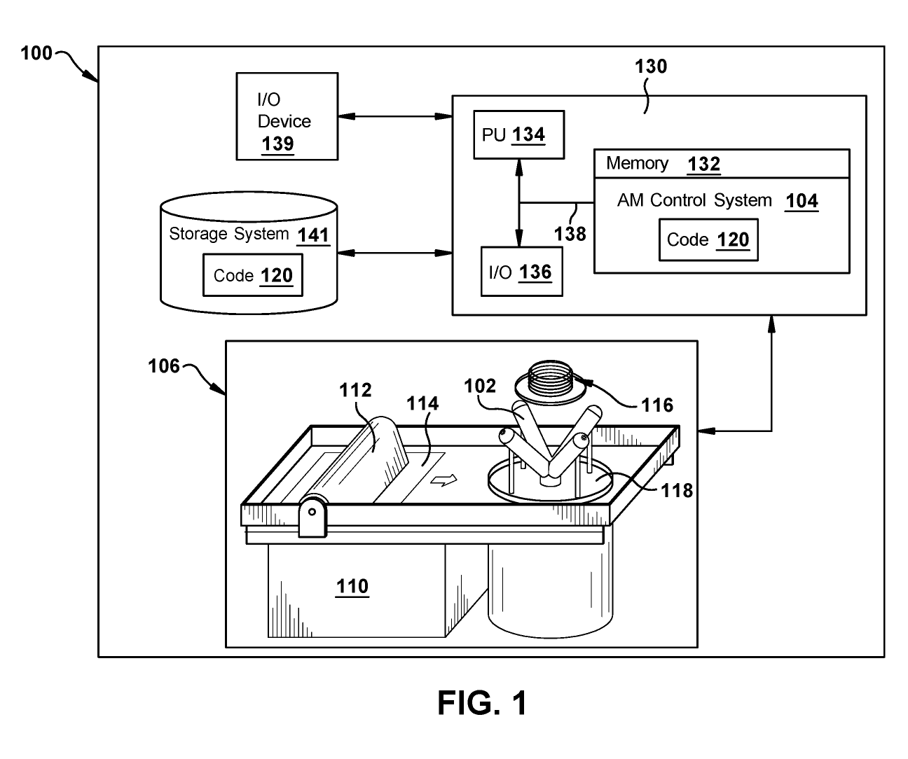

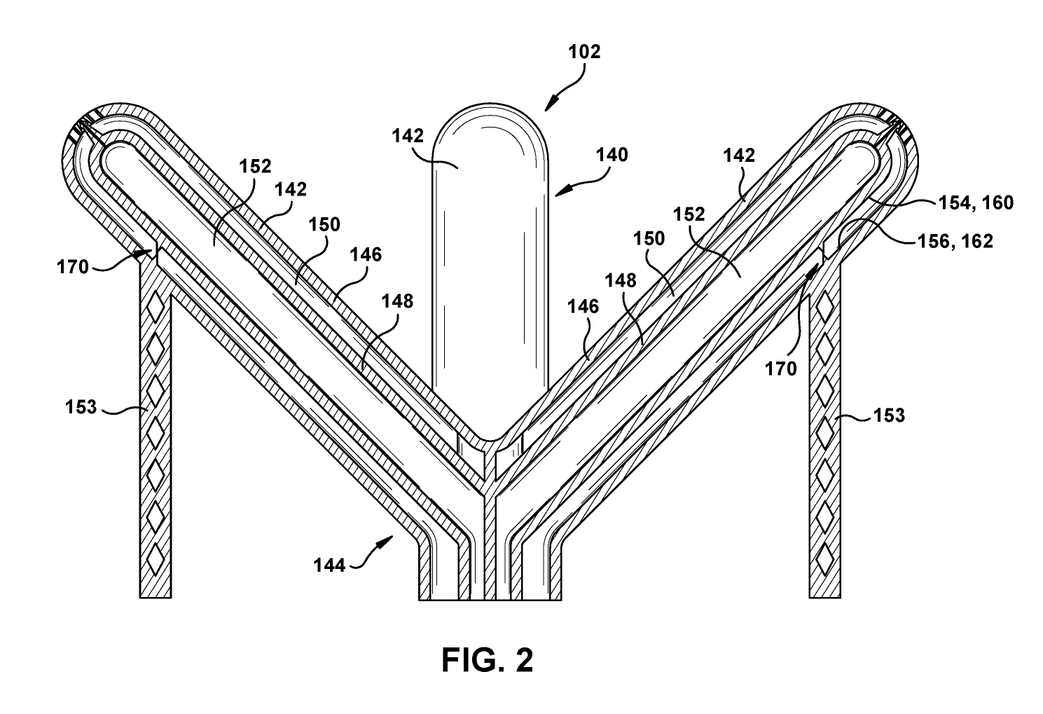

To illustrate an example of an additive manufacturing process, FIG. 1 shows a schematic/block view of an illustrative computerized additive manufacturing system 100 for generating an object 102. In this example, system 100 is arranged for DMLM, a metal powder additive manufacturing process. It is understood that the general teachings of the disclosure are equally applicable to other forms of additive manufacturing. Object 102 is illustrated as a double walled turbine element; however, it is understood that the additive manufacturing process can be readily adapted to manufacture any object. In some examples described herein, object 102 includes a fuel nozzle (FIG. 2). AM system 100 generally includes a computerized additive manufacturing (AM) control system 104 and an AM printer 106. AM system 100, as will be described, executes code 120 that includes a set of computer-executable instructions defining object 102 to physically generate the object using AM printer 106. Each AM process may use different raw materials in the form of, for example, fine-grain metal powder, a stock of which may be held in a chamber 110 of AM printer 106. In the instant case, object 102 may be made of metal or a metal alloy. As illustrated, an applicator 112 may create a thin layer of raw material 114 spread out as the blank canvas from which each successive slice of the final object will be created. In the example shown, a laser or electron beam 116 fuses particles for each slice, as defined by code 120. Various parts of AM printer 106 may move to accommodate the addition of each new layer, e.g., a build platform 118 may lower and/or chamber 110 and/or applicator 112 may rise after each layer.

AM control system 104 is shown implemented on computer 130 as computer program code. To this extent, computer 130 is shown including a memory 132, a processor 134, an input/output (I/O) interface 136, and a bus 138. Further, computer 130 is shown in communication with an external I/O device/resource 139 and a storage system 141. In general, processor 134 executes computer program code, such as AM control system 104, that is stored in memory 132 and/or storage system 141 under instructions from code 120 representative of object 102. While executing computer program code, processor 134 can read and/or write data to/from memory 132, storage system 141, I/O device 139 and/or AM printer 106. Bus 138 provides a communication link between each of the objects in computer 130, and I/O device 139 can comprise any device that enables a user to interact with computer 130 (e.g., keyboard, pointing device, display, etc.). Computer 130 is only representative of various possible combinations of hardware and software. For example, processor 134 may comprise a single processing unit, or be distributed across one or more processing units in one or more locations, e.g., on a client and server. Similarly, memory 132 and/or storage system 141 may reside at one or more physical locations. Memory 132 and/or storage system 141 can comprise any combination of various types of non-transitory computer readable storage medium including magnetic media, optical media, random access memory (RAM), read only memory (ROM), etc. Computer 130 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 132, storage system 141, etc.) storing code 120 representative of object 102. As noted, code 120 includes a set of computer-executable instructions defining object 102 that can be used to physically generate the object, upon execution of the code by system 100. For example, code 120 may include a precisely defined 3D model of object 102 and can be generated from any of a large variety of well-known computer aided design (CAD) software systems such as AutoCAD®, TurboCAD®, DesignCAD 3D Max, etc. In this regard, code 120 can take any now known or later developed file format. For example, code 120 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 120 may be translated between different formats, converted into a set of data signals and transmitted, received as a set of data signals and converted to code, stored, etc., as necessary. Code 120 may be an input to system 100 and may come from a part designer, an intellectual property (IP) provider, a design company, the operator or owner of system 100, or from other sources. In any event, AM control system 104 executes code 120, dividing object 102 into a series of thin slices that it assembles using AM printer 106 in successive layers of powder. In the DMLM example, each layer is melted or sintered to the exact geometry defined by code 120 and fused to the preceding layer. Subsequently, object 102 may be exposed to any variety of finishing processes, e.g., minor machining, sealing, polishing, assembly to another part, etc.

FIG. 2 shows an illustrative object 102 capable of employing a self-breaking support 170 according to the teachings of the disclosure. FIG. 2 shows a cross-sectional view of a fuel nozzle system 140 that includes at least 3 fuel nozzles 142 that extend from a center region 144 at which they are coupled. It is noted that fuel nozzle system 140 may include one or two nozzles in other embodiments. Each fuel nozzle 142 includes a pair of concentric tubes 146, 148 (outer 146, inner 148), creating plenums 150, 152 for fuel and air. Fuel nozzle system 140 may be formed using AM processes with conventional, removable vertical supports 153 supporting one or more outer tubes 146. As illustrated, inner tube 148 includes a first surface 154 that is vertically opposed to a second surface 156 of outer tube 146. As used herein, “vertically opposed” indicates that one surface includes at least a portion thereof vertically above at least a portion of the other surface. In the instant example, each fuel nozzle 142 extends at approximately 45° relative to horizontal. Consequently, first surface 154 includes a first vertically angled surface 160, and the second surface 156 includes a second vertically angled surface 162 vertically opposed to first vertically angled surface 160 and extending at a 45°. As used herein, “vertically angled” indicates the surface is neither vertical nor horizontal, and extends at an angle relative to horizontal other than 90°.

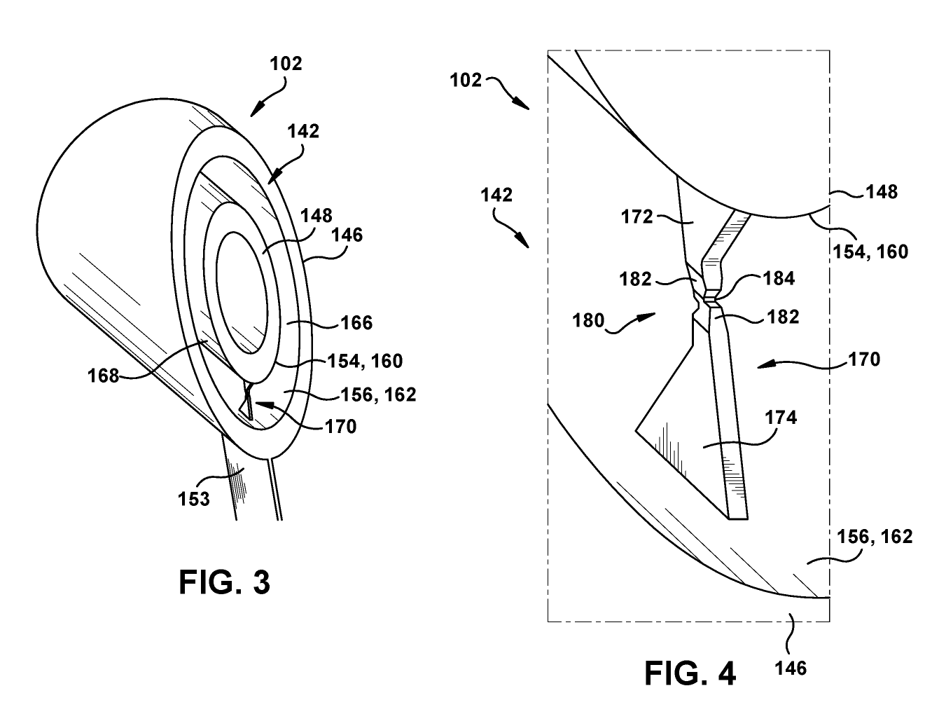

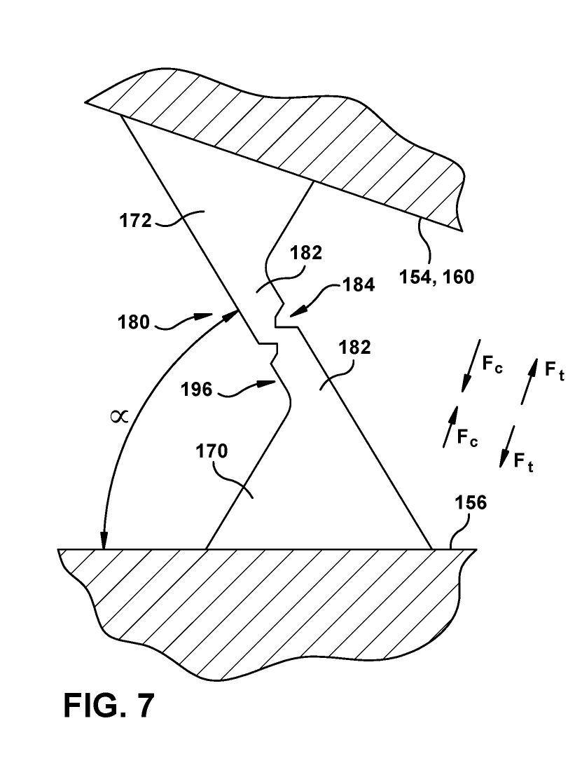

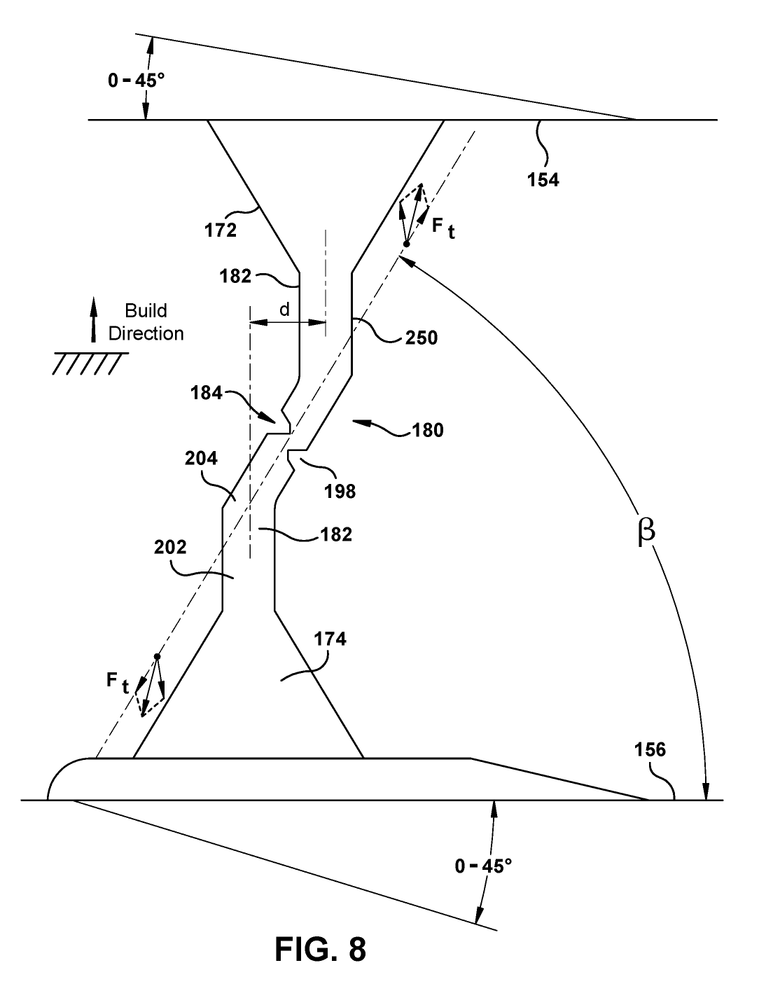

As shown best in the cross-sectional perspective view of an end of a fuel nozzle 142 in FIG. 3, the tubular arrangement provides first vertically angled surface 160 including an inner rounded surface 166 and second vertically angled surface 162 including an outer rounded surface 168 that is vertically opposed to inner rounded surface 166. As understood in the AM field, due to printability reasons, most vertically angled surfaces are at no more than 45° from horizontal. Accordingly, first vertically angled surface 160 may be angled no greater than 45° from horizontal and second vertically angled surface may be angled no greater than 45° from horizontal. It is emphasized that fuel nozzle system 140 is only illustrative, and as will be apparent herein, the teachings of the disclosure are applicable to vertically angle surfaces and other vertically opposed surfaces, one or more of which may be horizontal. See e.g., FIGS. 7 and 8 for horizontal vertically opposed surfaces.

While tubes 146, 148 are coupled in selected locations (at build platform 118 (FIG. 1) and at connection points a nozzle ends) to maintain concentricity, it is advantageous to provide additional support thereof. To this end, FIGS. 2-3 also show a self-breaking support 170 according to embodiments of the disclosure. While shown in two particular locations in FIG. 2, it is emphasized that self-breaking support 170 may be provided anywhere deemed advantageous in any object 102 formed by metal powder AM processes. Any number of self-breaking supports 170 may be employed. Each self-breaking support 170 can be added into code 120 (or any preceding or subsequent code format) for object 102 in any location desired, and can be printed along with object 102.

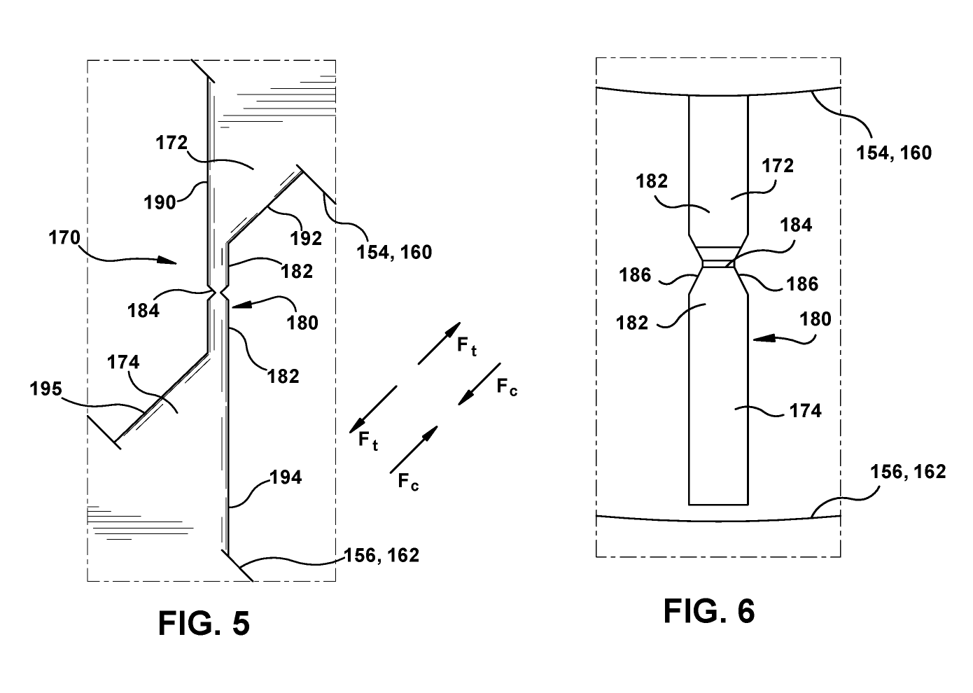

FIG. 4 shows an enlarged perspective view of self-breaking support 170, and FIG. 5 shows a side view of self-breaking support 170. According to embodiments of the disclosure, self-breaking support 170 includes a first base 172 coupled to first surface 154 and extending towards second surface 156. Further self-breaking support 170 includes a second base 174 coupled to second surface 156 and extending towards first surface 154. A self-breaking link 180 couples first base 170 to second base 172 and provides support between surfaces 154, 156. As will be described in greater detail herein, self-breaking link 180 includes a body 182 and a weakened zone 184 in the body that allows for breaking of link 180 when sufficient tensile or compressive stress is applied thereto.

Each base 172, 174 may take any form necessary to support or position self-breaking support 170 where support of surfaces during metal powder additive manufactured is desired. In one example, shown in FIG. 5, first base 172 has a first side 190 extending substantially vertically and a second side 192 extending substantially perpendicular from first surface 154. In FIG. 5, first surface 154 includes vertically angled surface 160. Similarly, second base 174 has a first side 194 extending substantially vertically and a second side 195 extending substantially perpendicular from second surface 156. In FIG. 5, second surface 156 includes vertically angled surface 162. In this fashion, for vertically angle surfaces 160, 162, support 170 provides a vertical support therebetween that directs a load vertically.

Weakened zone 184 may include any manner of physical structure capable of causing body 180 to break under a desired stress. In the example shown in the enlarged front view of FIG. 6, weakened zone 184 includes a number of cross-sectionally thinner areas 186 in body 182, compared to the remaining areas of body 182. Weakened zones 184 can include any variety of shapes, e.g., angles, radiuses, etc. According to embodiments of the disclosure, in contrast to conventional techniques, weakened zone 184 is configured to break on its own, i.e., without human intervention, due to thermal stresses experienced during metal powder AM. That is, the breaking of self-breaking supports 170 is realized by thermal stresses, which are accumulated by object 102 during absorption of the high amounts of heat from melting/sintering metal powder layers by laser/electron beam during the metal powder AM process. In particular, breaking of supports 170 most frequently takes place during the cooling phase of object 102 being manufactured. Shrinking of material during the cooling phase causes creation of tensile or compressive stresses, which result is thermal movement force. The force that causes the breakage can be a tensile force Ft and/or a compressive force Fc. In any event, this force breaks weakened zone 184. Self-breaking supports 170 do not need any additional treatment after removal of object 102 from AM system 100. Yet, self-breaking supports 170 are stable during the metal powder AM process, e.g., DMLM, and can readily support surfaces 154, 156. In this manner, self-breaking support 170 breakage during metal powder AM is in contrast to conventional supports that either break during operation of the object or must be removed or modified by, e.g., machining, after the AM process. Self-breaking supports 170 can remain in place.

Self-breaking support 170 can take a variety of alternative forms, which can be selected based on a number of factors such as but not limited to: any number of characteristics of first and second surfaces 154, 156, e.g., distance therebetween, relative angles, angle of each, etc.; the desired amount of support necessary; and/or the desired stress required to break the support. In FIG. 5, as noted, self-breaking link 180 extends substantially vertically between first base 172 and second base 174. As shown in the side view of FIG. 7, first surface 154 may include a vertically angled surface 160, while second surface 156 is substantially horizontal. As shown in FIG. 7, in another embodiment, body 182 of self-breaking link 180 includes at least a portion 196 extending at an angle (a) relative to horizontal, e.g., up to approximately 45°, between first base 172 and second base 174. Portion 196 includes weakened zone 184. Again, a tensile force Ft and/or a compressive force Fc can break weakened zone 184.

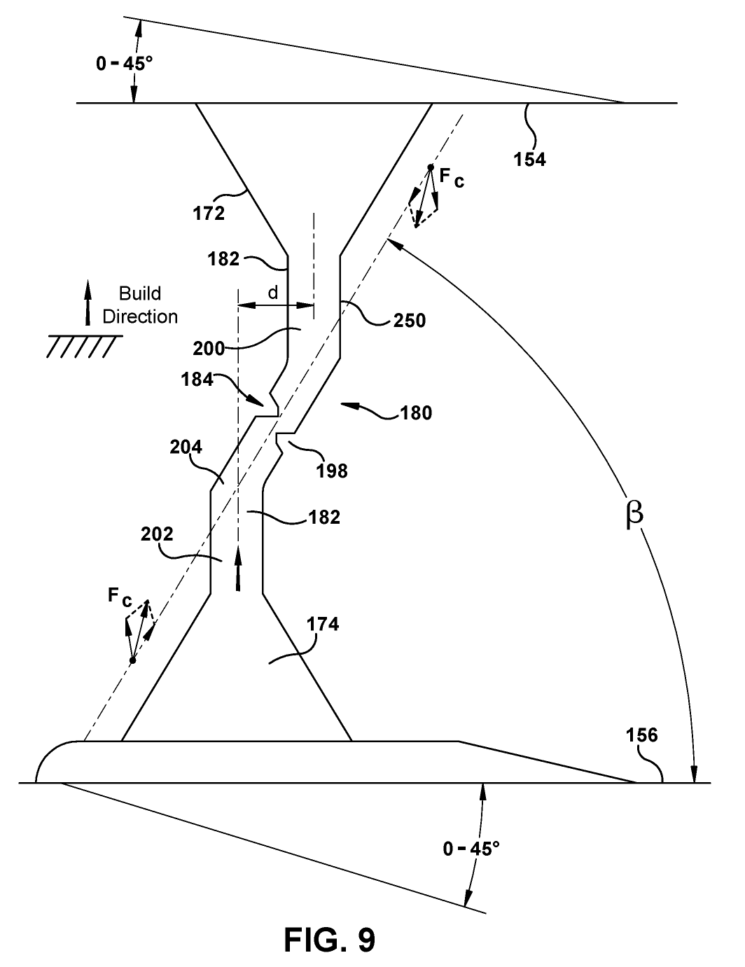

In another embodiment, shown in side views in FIGS. 8 and 9, first surface 154 and second surface 156 are both horizontal, i.e., vertically opposed but with no angles relative to horizontal. In this embodiment, body 182 of self-breaking link 180 may include a first portion 200 extending vertically from first base 172, a second portion 202 extending vertically from second base 174, and a third portion 204 extending at an angle β, e.g., of approximately 45°, relative to horizontal between first portion 200 and second portion 202. Third portion 204 includes weakened zone 184. As shown in FIGS. 8 and 9, this configuration creates a dislocation d that assists in causing breakage at weakened zone 184, regardless of whether a tensile force Ft is experienced, as shown in FIG. 8, or a compressive force Fc is experienced, as shown in FIG. 9. That is, weakened zone 184 breaks under either a tensile force Ft or a compression force Fc applied during metal powder additive manufacture of object 102 (FIG. 1) including first and second surfaces 154, 156.

First base 172 and second base 174 can have any shape necessary to ensure they are securely formed with surfaces 154, 156. In embodiments shown herein, each base has a substantially triangular cross-section (excepting where body 180 extends therefrom). Where, for example, surfaces 154, 156 are not planar, bases 172, 174 can take a variety of alternative shapes to accommodate secure formation thereof with the surfaces. It is noted that while bases 172, 174 are generally vertically aligned in FIG. 5, they may be vertically offset, as in FIGS. 7-9, in such a way as to allow for support but also easy breakage of weakened zone 184.

Weakened zone 184 may also take a variety of alternative forms. For example, in FIGS. 8 and 9, one side of weakened zone 184 includes a radius 198 to avoid creating an overhang on the one side.

A method for manufacturing an object 102, and in particular a metallic object, according to embodiments of the disclosure may include forming object 102 with self-breaking support 170, as described herein, using a metal powder additive manufacturing process (as in FIG. 1). As noted, first base 172 may be coupled to first surface 154 of the object and extend towards second surface 156 of the object that is vertically opposed to the first surface. Second base 174 may be coupled to second surface 156 and extending towards the first surface. Further, self-breaking link 180 may couple first base 172 to second base 174 and include body 182 and weakened zone 184 in the body. The method may include allowing self-breaking link 170 to break during cooling of at least a portion of object 102 during the forming. The method may also include support 170 within object 102 such that it is present during use of the object.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A self-breaking support for a vertically opposed first and second surfaces of an object, the self-breaking support comprising:
a first base coupled to the first surface and extending towards the second surface;
a second base coupled to the second surface and extending towards the first surface; and
a self-breaking link coupling the first base to the second base, the self-breaking link including a body and a weakened zone in the body.

2. The self-breaking support of claim 1, wherein the first surface includes a first vertically angled surface and the second surface includes a second vertically angled surface vertically opposed to the first vertically angled surface.

3. The self-breaking support of claim 2, wherein the first vertically angled surface includes an inner rounded surface and the second vertically angled surface includes an outer rounded surface that is vertically opposed to the inner rounded surface.

4. The self-breaking support of claim 2, wherein the first vertically angled surface is angled no greater than 45° from horizontal and the second vertically angled surface is angled no greater than 45° from horizontal.

5. The self-breaking support of claim 4, wherein the first base has a first side extending substantially vertically and a second side extending substantially perpendicular from the first vertically angled surface, and
wherein the second base has a first side extending substantially vertically and a second side extending substantially perpendicular from the second vertically angled surface.

6. The self-breaking support of claim 1, wherein the self-breaking link extends substantially vertically between the first base and the second base.

7. The self-breaking support of claim 1, wherein in the self-breaking link includes at least a portion extending at an angle relative to horizontal between the first base and the second base, wherein the at least a portion includes the weakened zone.

8. The self-breaking support of claim 1, wherein the body of the self-breaking link includes:
a first portion extending vertically from the first base;
a second portion extending vertically from the second base; and
a third portion extending at an approximately 45° angle relative to horizontal between the first portion and the second portion, the third portion including the weakened zone.

9. The self-breaking support of claim 1, wherein the object includes a metallic object, and the weakened zone breaks under either a tensile force or a compression force applied during a metal powder additive manufacturing of the metallic object including the first and second surfaces.

10. The self-breaking support of claim 1, wherein each of the first base and second base has a substantially triangular cross-section.

11. A method for manufacturing a metallic object, the method comprising:
forming the metallic object with a self-breaking support using a metal powder additive manufacturing process, the self-breaking support including:
a first base coupled to a first surface of the metallic object and extending towards a second surface of the metallic object that is vertically opposed to the first surface,
a second base coupled to the second surface and extending towards the first surface, and
a self-breaking link coupling the first base to the second base, the self-breaking link including a body and a weakened zone in the body; and
allowing the self-breaking link to break during cooling of at least a portion of the metallic object during the forming.

12. The method of claim 11, wherein the first surface includes a first vertically angled surface and the second surface includes a second vertically angled surface that is vertically opposed to the first vertically angled surface.

13. The method of claim 12, wherein the first vertically angled surface includes an inner rounded surface and the second vertically angled surface includes an outer rounded surface that is vertically opposed to the inner rounded surface.

14. The method of claim 12, wherein the first vertically angled surface is angled no greater than 45° from horizontal and the second vertically angled surface is angled no greater than 45° from horizontal.

15. The method of claim 12, wherein the first base has a first side extending substantially vertically and a second side extending substantially perpendicular from the first vertically angled surface, and
wherein the second base has a first side extending substantially vertically and a second side extending substantially perpendicular from the second vertically angled surface.

16. The method of claim 11, wherein in the self-breaking link extends substantially vertically between the first base and the second base.

17. The method of claim 11, wherein in the self-breaking link extends at an angle relative to horizontal between the first base and the second base.

18. The method of claim 11, wherein the body of the self-breaking link includes:
a first portion extending vertically from the first base;
a second portion extending vertically from the second base; and
a third portion extending at an approximately 45° angle relative to horizontal between the first portion and the second portion, the third portion including the weakened zone.

19. The method of claim 11, wherein allowing the self-breaking link to break during cooling of the at least a portion of the metallic object during the forming includes breaking the weakened zone breaks under either a tensile force or a compression force.

20. The method of claim 11, further comprising leaving the support within the metallic object.
